(19) United States
(12) Patent Application Publication
(10) Pub. No.: US 2026/0331769 A1
(43) Pub. Date: Oct. 22, 2026

(54) RADIO WAVE REFLECTING DEVICE

(71) Applicant: Japan Display Inc., Tokyo (JP)

(72) Inventors: Kazuki MATSUNAGA, Tokyo (JP); Shinichiro OKA, Tokyo (JP); Mitsutaka OKITA, Tokyo (JP); Daiichi SUZUKI, Tokyo (JP)

(73) Assignee: Japan Display Inc., Tokyo (JP)

(21) Appl. No.: 19/710,731

(22) Filed: Jun. 17, 2026

Related U.S. Application Data
(63) Continuation of application No. PCT/JP2024/046134, filed on Dec. 26, 2024.

(30) Foreign Application Priority Data
Dec. 28, 2023 (JP) 2023-223637

(51) Int. Cl. H01Q 3/46; H01Q 3/04; H01Q 15/14; H01Q 15/16

(52) U.S. Cl. CPC H01Q 3/46; H01Q 3/04; H01Q 15/148; H01Q 15/166

(57) ABSTRACT

A radio wave reflecting device according to an embodiment of the present invention includes: a radio wave reflection unit having a radio wave reflector on which a plurality of reflective elements is arranged; a rotating mechanism attached to the radio wave reflector and rotating the radio wave reflector about at least one axis; and a control device controlling the rotation of the radio wave reflector by the rotating mechanism. The present invention can provide a radio wave reflecting device with improved amplitude while reducing the number of reflective elements that cannot be set to the desired phase.

### CROSS-REFERENCE TO RELATED APPLICATIONS

This application is a Continuation of International Patent Application No. PCT/JP2024/046134, filed on Dec. 26, 2024, which claims the benefit of priority to Japanese Patent Application No. 2023-223637, filed on Dec. 28, 2023, the entire contents of each are incorporated herein by reference.

### FIELD

An embodiment of the present invention relates to a radio wave reflecting device.

### BACKGROUND

A phased array antenna device controls directivity with an antenna fixed by adjusting an amplitude and a phase of a high-frequency signal applied to each of a plurality of antenna elements arranged in a planar manner. A phased array antenna device requires a phase shifter. For example, Japanese laid-open patent publication No. H11-103201 and Japanese Patent laid-open patent publication No. 2019-530387 disclose phased array antenna devices using a phase shifter that utilizes changes in a dielectric constant due to an alignment state of liquid crystal.

### SUMMARY

A radio wave reflecting device according to an embodiment of the present invention includes: a radio wave reflection unit having a radio wave reflector on which a plurality of reflective elements is arranged; a rotating mechanism attached to the radio wave reflector and rotating the radio wave reflector about at least one axis; and a control device controlling the rotation of the radio wave reflector by the rotating mechanism.

### BRIEF DESCRIPTION OF DRAWINGS

FIG. 1 is a diagram showing a configuration of a radio wave reflecting device according to an embodiment of the present invention.

FIG. 2 is a diagram showing a configuration of a radio wave reflection unit according to an embodiment of the present invention.

FIG. 3 is a diagram showing a configuration of a radio wave reflector according to an embodiment of the present invention.

FIG. 4 is a plan view showing a configuration of a reflective element corresponding to an inset in FIG. 3.

FIG. 5 is a cross-sectional view along A1-A2 of FIG. 4.

FIG. 6 is a diagram showing a state in which no voltage is applied between a patch electrode and a conductive layer when a radio wave reflector according to an embodiment of the present invention is in operation.

FIG. 7 is a diagram showing a state in which a control signal is applied to a patch electrode when a radio wave reflector according to an embodiment of the present invention is in operation.

FIG. 8 is a diagram for explaining a phase shift amount of a reflective element.

FIG. 9 is a graph showing an example of a change in the phase shift amount of a reflective element.

FIG. 10 is a diagram showing a state in which a radio wave reflector is rotated by θ₀.

FIG. 11 is a diagram for explaining a phase shift amount of a reflective element based on a control signal applied to a patch electrode when a radio wave reflector is rotated by θ₀ by a rotating mechanism.

FIG. 12 is a block diagram showing an example of a configuration of a drive control function according to an embodiment of the present invention.

FIG. 13 is a diagram showing an example calculation of an optimal rotation angle and a corresponding optimal phase shift amount for a radio wave reflector according to an embodiment of the present invention.

FIG. 14 is a diagram showing an example calculation of an optimal rotation angle and a corresponding optimal phase shift amount for a radio wave reflector according to an embodiment of the present invention.

FIG. 15 is a diagram showing an example calculation of an optimal rotation angle and a corresponding optimal phase shift amount for a radio wave reflector according to an embodiment of the present invention.

FIG. 16 is a diagram showing an example calculation of an optimal rotation angle and a corresponding optimal phase shift amount for a radio wave reflector according to an embodiment of the present invention.

### DESCRIPTION OF EMBODIMENTS

In a phased array antenna device, when a change in the amount of phase shift of each antenna element is less than 360°, a desired phase may not be set for each antenna element. In this case, the amplitude (reflectance) of the phased array antenna device deteriorates. Therefore, reducing the number of antenna elements that cannot be set to the desired phase leads to an improvement in amplitude. On the other hand, there is a trade-off relationship between the change in the amount of phase shift and the amplitude, and when attempting to improve the amplitude of the phased array antenna device, the change in the amount of phase shift of the antenna element reduces, and the number of antenna elements that cannot be set to the desired phase may increase.

According to an embodiment of the present invention, it is possible to provide a radio wave reflecting device with improved amplitude while reducing the number of reflective elements that cannot be set to the desired phase.

Hereinafter, embodiments of the present invention will be described with reference to the drawings and the like. However, the present invention can be implemented in many different ways and is not limited to the description of the embodiments exemplified below. For clarity of explanation, the drawings may be schematically represented in terms of width, thickness, shape, and the like of respective portions as compared with actual embodiments. However, the drawings are merely examples, and do not limit the interpretation of the present invention. Furthermore, in the present specification and drawings, elements similar to those previously described with respect to the preceding figures may be denoted by the same reference signs or numbers followed by a letter, such as a and b, and detailed descriptions may be omitted as appropriate. In addition, the terms “first” and “second” appended to each element are convenient labels used to distinguish each element and have no further meaning unless specifically explained.

In the case where a member or region is to be “on (or under)” another member or region in the present specification, unless otherwise specified, this includes not only the case where it is directly above (or below) the other member or region, but also the case where it is above (or below) the other member or region, that is, it also includes the case where another component is included above (below) the other member or region.

The radio wave reflecting device of the present invention includes a rotating mechanism on a back surface located on the opposite side of a radio wave incident surface the radio wave reflector, on which radio waves are incident. By tilting the radio wave reflector at a predetermined angle by this rotating mechanism, the incident angle of the radio wave incident on the radio wave reflector can be adjusted to a desired angle. As a result, the number of reflective elements that cannot be set to the desired phase can be reduced, and the amplitude of the radio wave reflector can be improved. The radio wave reflecting device is also referred to as an IRS (Intelligent Reflecting Surface) or the like.

### Radio Wave Reflecting Device

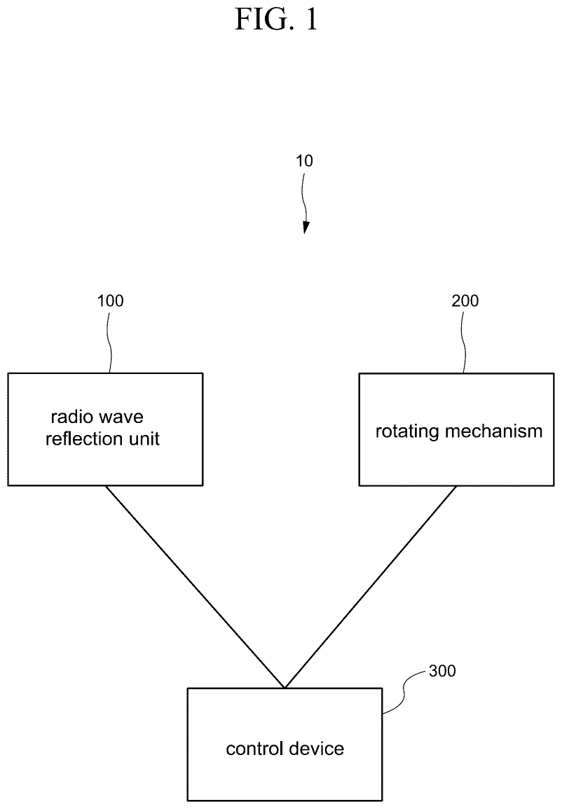

FIG. 1 is a diagram showing a configuration of a radio wave reflecting device 10 according to an embodiment of the present invention. The radio wave reflecting device 10 includes a radio wave reflection unit 100, a rotating mechanism 200, and a control device 300. The radio wave reflection unit 100 and the rotating mechanism 200 are connected to the control device 300 by wire or wirelessly.

### Radio Wave Reflection Unit

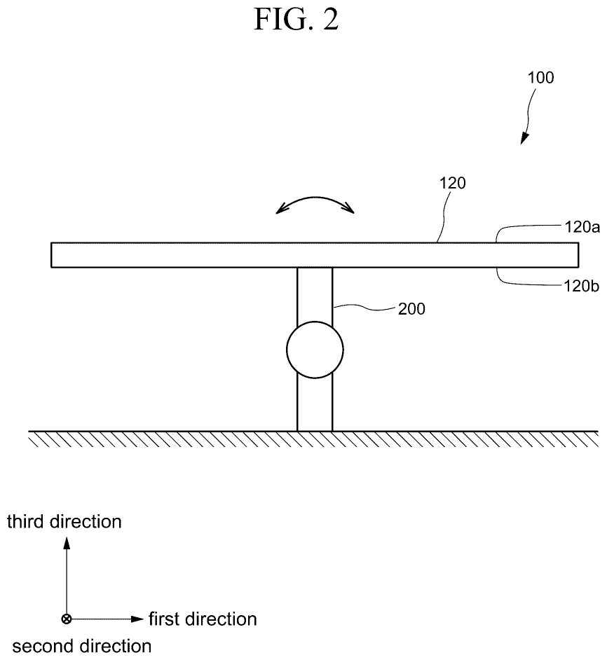

FIG. 2 is a diagram showing a configuration of the radio wave reflection unit 100 according to an embodiment of the present invention. The radio wave reflection unit 100 includes a radio wave reflector 120. The rotating mechanism 200 is attached to the radio wave reflection unit 100. The radio wave reflector 120 includes a radio wave incident surface 120a and a back surface 120b. The radio wave reflecting surface 120a is a surface on which radio waves are incident, and the back surface 120b is a surface located on the opposite side of the radio wave incident surface 120a. The rotating mechanism 200 is attached to the back surface 120b side.

### Radio Wave Reflector

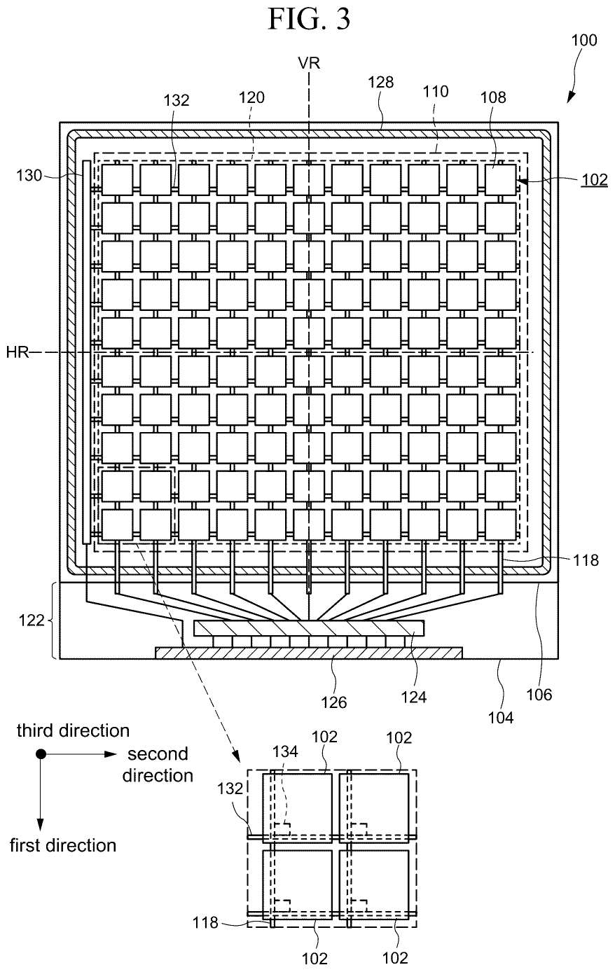

A configuration of the radio wave reflector 120 of the radio wave reflection unit 100 will be described. FIG. 3 is a plan view showing a configuration of the radio wave reflector 120 according to an embodiment of the present invention. The radio wave reflector 120 comprises a plurality of reflective elements (antenna elements) 102. For example, the plurality of reflective elements 102 is arranged in a first direction (for example, a column direction) and a second direction (for example, a row direction) different from the first direction. The reflective elements 102 are arranged so that a plurality of patch electrodes 108 described later faces the incident surface of radio waves. The radio wave reflector 120 has a flat plate shape, and the plurality of patch electrodes 108 of each reflective element 102 is arranged in a matrix along the first direction and the second direction within this flat plate-shaped surface.

The radio wave reflection unit 100 has a structure in which the plurality of reflective elements 102 is integrated on a single dielectric substrate (dielectric layer) 104. As shown in FIG. 3, the radio wave reflection unit 100 has a structure in which the dielectric substrate (dielectric layer) 104 on which the plurality of patch electrodes 108 described later is arranged and a counter substrate 106 on which a conductive layer 110 is provided are stacked so that the patch electrode 108 and the conductive layer 110 face each other, and a liquid crystal layer (not shown) is provided between the two substrates. The radio wave reflector 120 is formed in a region where the plurality of patch electrodes 108 and the conductive layer 110 overlap. The dielectric substrate (dielectric layer) 104 and the counter substrate 106 are bonded together with a sealing material 128, and the liquid crystal layer is provided in a region inside the sealing material 128.

The dielectric substrate (dielectric layer) 104 has a peripheral region 122 extending outside the counter substrate 106 in addition to a region facing the counter substrate 106. A first drive circuit 124 and a terminal part 126 are provided in the peripheral region 122. The first drive circuit 124 outputs a control signal to the patch electrode 108. The terminal part 126 is a region that connects to an external circuit (for example, a flexible printed circuit substrate (not shown)). A signal for controlling the first drive circuit 124 is input to the terminal part 126.

As described above, the plurality of patch electrodes 108 is arranged in the first direction (column direction) and the second direction (row direction) on the dielectric substrate (dielectric layer) 104. A plurality of first signal lines 118 extending in the first direction and a plurality of second signal lines 132 extending in the second direction are disposed on the dielectric substrate (dielectric layer) 104. The plurality of first signal lines 118 and the plurality of second signal lines 132 are arranged to cross each other with an insulating layer (not shown) interposed therebetween. The plurality of first signal lines 118 is connected to the first drive circuit 124, and the plurality of second signal lines 132 is connected to a second drive circuit 130. The first drive circuit 124 outputs the control signal, and the second drive circuit 130 outputs a scanning signal. The first signal line 118 is electrically connected to the plurality of reflective elements 102 arranged in the first direction (column direction). In other words, the plurality of reflective elements 102 arranged in the first direction (column direction) is connected by the first signal line 118. The radio wave reflector 120 has a configuration in which a plurality of rows of reflective element arrays connected by the first signal line 118 is arranged in the second direction (row direction).

FIG. 3 includes an inset enlarging the arrangement of four reflective elements 102 and two first signal lines 118 and two second signal lines 132. A switching element 134 is provided in each of the four reflective elements 102. Switching of the switching element 134, that is, on and off, is controlled by the scanning signal applied to the second signal line 132. The reflective element 102 in which the switching element 134 is turned on becomes conductive with the first signal line 118, and a control signal is applied thereto. For example, the switching element 134 is formed of a thin film transistor. According to such a configuration, the plurality of patch electrodes 108 arranged in the second direction (row direction) can be selected for each row, and a control signal with a different voltage level can be applied to each row.

The radio wave reflector 120 shown in FIG. 3 can control the propagation direction of the reflected wave of the radio wave incident on the radio wave reflector 120 in the left-right direction of the drawing about a reflection axis VR parallel to the first direction (column direction) and can also control the propagation direction of the reflected wave in the up-down direction of the drawing about a reflection axis HR parallel to the second direction (row direction). That is, the radio wave reflector 120 has the reflection axis VR parallel to the first direction (column direction) and the reflection axis HR parallel to the second direction (row direction), and can control a reflection angle in a direction with the reflection axis VR as the rotating axis and in a direction with the reflection axis HR as the rotating axis.

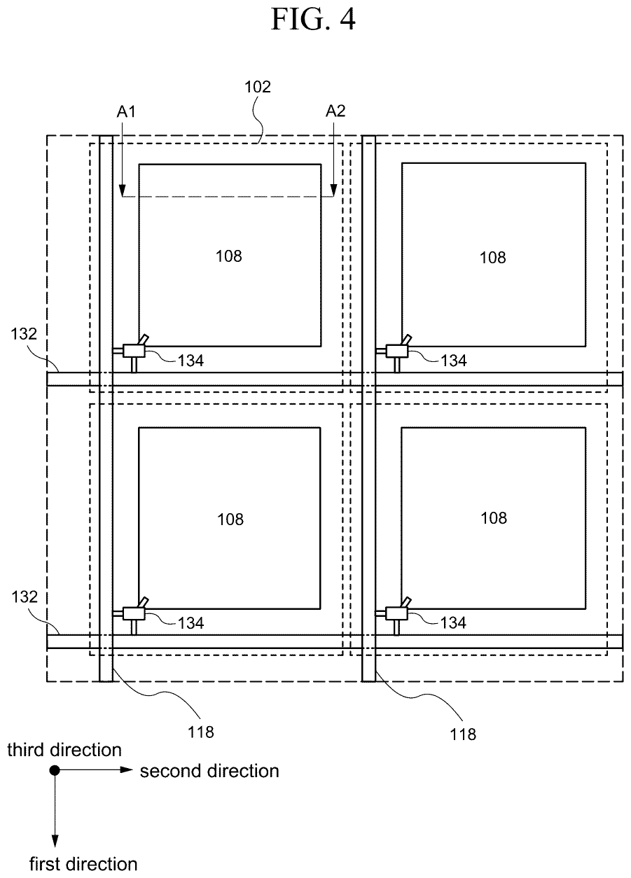

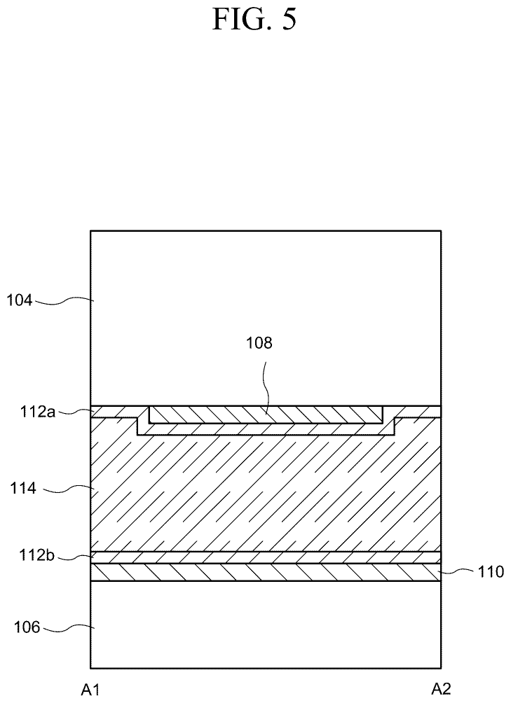

FIG. 4 is a plan view showing a configuration of the reflective element 102 corresponding to the inset of FIG. 3. FIG. 5 is a cross-sectional view along A1-A2 of FIG. 4. Referring to FIG. 4 and FIG. 5, the reflective element 102 includes the dielectric substrate 104, the counter substrate 106, the patch electrode 108, the conductive layer 110, a liquid crystal layer 114, a first alignment film 112a, and a second alignment film 112b. In the reflective element 102, the dielectric substrate 104 can also be regarded as a dielectric layer forming one layer. The patch electrode 108 is provided on the dielectric substrate (dielectric layer) 104, and the conductive layer 110 is provided on the counter substrate 106. The first alignment film 112a is provided on the dielectric substrate (dielectric layer) 104 to cover the patch electrode 108, and the second alignment film 112b is provided on the counter substrate 106 to cover the conductive layer 110. The patch electrode 108 and the conductive layer 110 are arranged to face each other, and the liquid crystal layer 114 is provided therebetween. The first alignment film 112a is interposed between the patch electrode 108 and the liquid crystal layer 114, and the second alignment film 112b is interposed between the conductive layer 110 and the liquid crystal layer 114.

Although not shown, the dielectric substrate (dielectric layer) 104 and the counter substrate 106 are bonded together with a sealing material. The dielectric substrate (dielectric layer) 104 and the counter substrate 106 are arranged to face each other with a gap, and the liquid crystal layer 114 is provided in a region surrounded by the sealing material. The liquid crystal layer 114 is provided to fill the gap between the dielectric substrate (dielectric layer) 104 and the counter substrate 106. A distance between the dielectric substrate (dielectric layer) 104 and the counter substrate 106 may be 20-μm to 100 μm, for example, 50 μm. Since the patch electrode 108, the conductive layer 110, the first alignment film 112a, and the second alignment film 112b are provided between the dielectric substrate (dielectric layer) 104 and the counter substrate 106, precisely speaking, a distance between the first alignment film 112a and the second alignment film 112b provided on each of the dielectric substrate 104 and the counter substrate 106 is equal to the thickness of the liquid crystal layer 114. Although not shown, a spacer may be provided between the dielectric substrate (dielectric layer) 104 and the counter substrate 106 for maintaining a constant distance.

The control signal for controlling the alignment of liquid crystal molecules in the liquid crystal layer 114 is applied to the patch electrode 108 via the first signal line 118. The control signal is a DC voltage signal or a polarity inversion signal in which a positive DC voltage and a negative DC voltage alternately invert. A ground voltage or an intermediate level voltage of the polarity inversion signal is applied to the conductive layer 110. When the control signal is applied to the patch electrode 108, the alignment state of the liquid crystal molecules contained in the liquid crystal layer 114 changes. A liquid crystal material having dielectric anisotropy is used for the liquid crystal layer 114. For example, nematic liquid crystal, smectic liquid crystal, cholesteric liquid crystal, or discotic liquid crystal can be used as the liquid crystal layer 114. The dielectric constant of the liquid crystal layer 114 having dielectric anisotropy changes due to a change in the alignment state of the liquid crystal molecules. The dielectric constant of the liquid crystal layer 114 can be changed by the control signal applied to the patch electrode 108, thereby allowing the reflective element 102 to delay the phase of the reflected wave when reflecting radio waves.

The frequency bands of radio waves reflected by the reflective element 102 are the very high frequency (VHF) band, ultra-high frequency (UHF) band, super high frequency (SHF) band, tremendously high frequency (THF) band, and extra high frequency (EHF) band. The alignment of the liquid crystal molecules in the liquid crystal layer 114 changes in response to the control signal applied to the patch electrode 108, but it does not respond significantly to the frequency of radio waves irradiated onto the patch electrode 108. Therefore, the reflective element 102 can control the phase of the reflected radio wave without being affected by the radio wave.

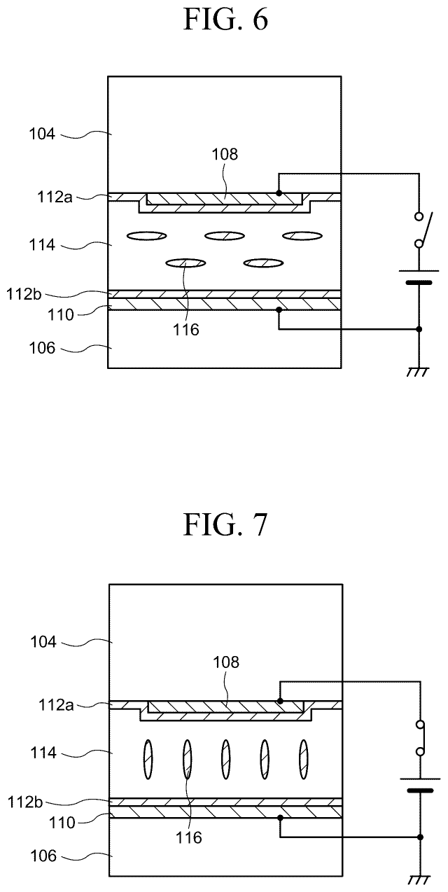

FIG. 6 shows a state in which no voltage is applied between the patch electrode 108 and the conductive layer 110 (referred to as a “first state”). FIG. 6 shows the case where the first alignment film 112a and the second alignment film 112b are horizontal alignment films. The long axes of a liquid crystal molecule 116 in the first state are aligned horizontally relative to the surfaces of the patch electrode 108 and the conductive layer 110 by the first alignment film 112a and the second alignment film 112b.

FIG. 7 shows a state in which the control signal (voltage signal) is applied to the patch electrode 108 (referred to as a “second state”). In the second state, the long axes of the liquid crystal molecule 116 are aligned perpendicular to the surfaces of the patch electrode 108 and the conductive layer 110 under the action of the electric field. The angle at which the long axes of the liquid crystal molecule 116 are aligned can also be aligned in a direction intermediate between the horizontal and vertical directions relative to the surfaces by adjusting the magnitude of the control signal applied to the patch electrode 108 (the magnitude of the electric field between the counter electrode and the patch electrode).

When the liquid crystal molecule 116 has positive dielectric anisotropy, the dielectric constant is higher in the second state than in the first state. Alternatively, when the liquid crystal molecule 116 has negative dielectric anisotropy, the apparent dielectric constant is lower in the second state than in the first state. The liquid crystal layer 114 having dielectric anisotropy can also be regarded as a variable dielectric layer. The reflective element 102 can be controlled to delay or not to delay the phase of the reflected wave by utilizing the dielectric anisotropy of the liquid crystal layer 114.

When the reflective element 102 reflects radio waves in a predetermined direction, it is preferable that the amplitude of the reflected radio wave is attenuated as little as possible. As is apparent from the structure shown in FIG. 5, when a radio wave propagating through the air is reflected by the reflective element 102, the radio wave passes through the dielectric substrate (dielectric layer) 104 twice. For example, the dielectric substrate (dielectric layer) 104 is formed of a dielectric material such as glass or resin. Since the phase velocity of the radio wave changes when passing through a dielectric, the thickness of the dielectric substrate (dielectric layer) 104 is adjusted so that the amplitude of the reflected wave is not attenuated. In this case, the thickness of the dielectric substrate (dielectric layer) 104 can be the length from the surface of the patch electrode 108 on the liquid crystal layer 114 side to the surface of the dielectric substrate (dielectric layer) 104 opposite to the surface on which the patch electrode 108 is provided.

The shape of the patch electrode 108 is preferably one that has rotational symmetry relative to the center of the patch electrode 108. For example, the shape of the patch electrode 108 may be a 4-fold rotationally symmetric shape and may have a square or rhombus shape in a plan view. In addition, the 4-fold rotationally symmetric shape may be a quadrilateral with each vertex chamfered, or a quadrilateral with each vertex rounded. In addition, the shape of the patch electrode 108 may be circular. In the present embodiment, the case where the patch electrode 108 is square in a plan view is shown. Since the shape of the patch electrode 108 has rotational symmetry relative to the center of the patch electrode 108, the anisotropy regarding radio wave reflection relative to vertical polarization and horizontal polarization of incident radio waves can be reduced. That is, the bias of vertical polarization and horizontal polarization can be suppressed, and vertical polarization and horizontal polarization can be reflected uniformly. In addition, when reflecting radio waves in the millimeter wave band of 24 GHz to 29 GHz, if the shape of the patch electrode 108 is square, the size of the patch electrode 108 may be approximately 3.0 mm×approximately 3.0 mm to approximately 4.5 mm×approximately 4.5 mm.

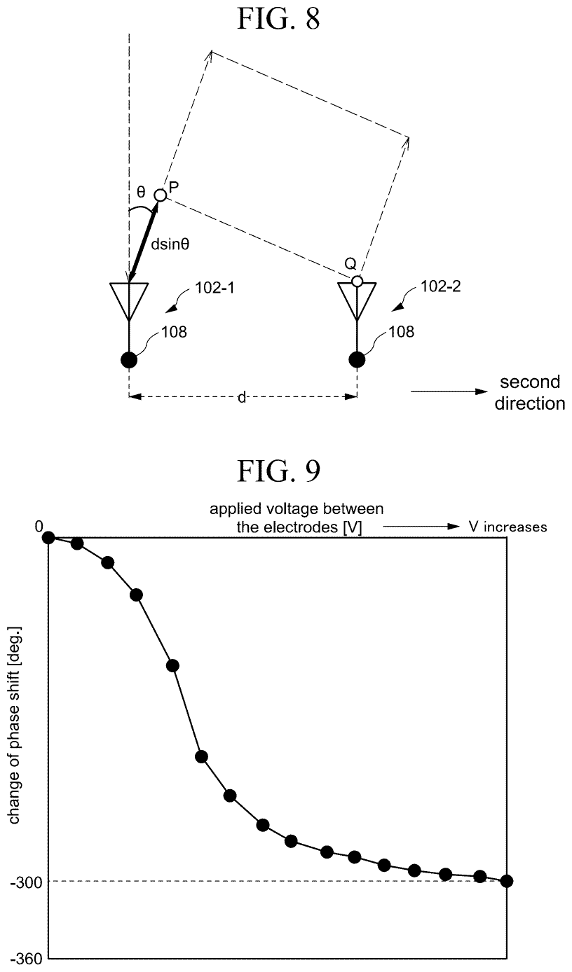

FIG. 8 is a diagram for explaining a phase shift amount δ of the reflective element 102 based on the control signal (voltage signal) applied to the patch electrode 108. FIG. 8 shows two reflective elements 102-1 and 102-2 adjacent in the second direction. As shown in FIG. 8, when reflecting a radio wave incident from the front on the radio wave reflector 120 in a θ direction, in other words, when aligning the phase of the radio wave reflected from the two adjacent reflective elements 102-1 and 102-2 in the θ direction, it is sufficient that the phases at points P and Q in the figure are aligned. Therefore, the phase shift amount δ of each reflective element 102 is determined based on the following Expression 1.

Δ=(2π/λ)×d sin θ (Expression 1)

In Expression 1 described above, λ indicates a wavelength of the radio wave, d indicates a distance (pitch) between the patch electrodes 108 adjacent in one direction, and θ indicates the reflection angle. That is, the voltage of the control signal applied to the patch electrode 108 of the reflective element 102-2 is set so that the phase of the reflected wave of the reflective element 102-2 is delayed by (2π/λ)×d sin θ compared to that of the reflected wave of the adjacent reflective element 102-1. For example, when the wavelength λ of the incident radio wave is 10.7 mm, the pitch d is 3.7 mm, and the reflection angle θ is 30°, the voltage of the control signal applied to the patch electrode 108 of the reflective element 102-2 is set so that the phase of the reflected wave from the reflective element 102-2 is delayed by 62.2° compared to that of the reflected wave from the reflective element 102-1.

In the radio wave reflector 120, the voltage of the control signal applied to the patch electrode 108 of each reflective element 102 is controlled based on the phase of the reflected wave of radio waves reflected by each reflective element 102, which is determined according to the phase shift amount δ calculated by Expression 1 described above. Hereinafter, the phase of the reflected wave set for each reflective element 102 according to the phase shift amount δ is referred to as “set phase”. In this case, if a change in the amount of phase shift of each reflective element 102 can be 360°, desired phase control can be achieved for all reflective elements 102 by adjusting the voltage of the applied control signal. However, there is a trade-off relationship between the amplitude (reflectance) of the radio wave reflector 120 and the change in the amount of phase shift of the reflective element 102, and when trying to achieve a sufficient amplitude for communication, the change in the amount of phase shift of the reflective element 102 becomes small.

FIG. 9 is a graph showing an example of a change in the amount of phase shift of an existing reflective element. In the graph shown in FIG. 9, the horizontal axis indicates the applied voltage between the electrodes of the reflective element (between the patch electrode 108 and the conductive layer 110 in the present embodiment), and the vertical axis indicates the change in the amount of phase shift [deg.]. The applied voltage shown on the horizontal axis indicates the voltage when the maximum power supply voltage of the drive circuit (for example, the first drive circuit 124 in the present embodiment) that applies a voltage to the electrode (for example, the patch electrode 108 in the present embodiment) is divided into 24 parts. As shown in FIG. 9, the change in the amount of phase shift of the existing reflective element is approximately 300°, which is less than 360°. In this case, if the set phase for the reflective element exceeds 300°, the desired phase cannot be set for that reflective element.

Similar to the reflective element shown in FIG. 9, when the change in the amount of phase shift of each reflective element 102 in the radio wave reflector 120 is less than 360°, the desired phase may not be set for each reflective element 102 depending on the set phase. When the number of reflective elements 102 for which a phase cannot be set increases, the amplitude of the radio wave reflector 120 decreases. To reduce the number of reflective elements 102 for which a phase cannot be set in the radio wave reflector 120, in the present embodiment, the rotating mechanism 200 is used to adjust the incident angle of the radio wave incident on the reflective element 102.

### Rotating Mechanism

Returning to FIG. 2, the rotating mechanism 200 will be described. As described above, the rotating mechanism 200 is attached to the back surface 120b side of the radio wave reflector 120. The rotating mechanism 200 supports the radio wave reflection unit 100 relative to the installation surface on which the radio wave reflecting device 10 is installed. Although not shown, when a support member is arranged on the installation surface where the radio wave reflecting device 10 is installed, the rotating mechanism 200 is attached to the support member and supports the radio wave reflection unit 100 relative to the support member. The rotating mechanism 200 rotates the radio wave reflector 120 about at least one axis. The configuration of the rotating mechanism 200 is not particularly limited as long as it can rotate the radio wave reflector 120 about at least one axis. In the present specification, “one-axis rotation” means rotation around one axis extending in a predetermined direction. In the present embodiment, as an example, the case in which the rotating mechanism 200 has a structure that rotates the radio wave reflector 120 in the left-right direction in the figure, with the second direction as the axis by means of a cylindrical rotating body, will be described.

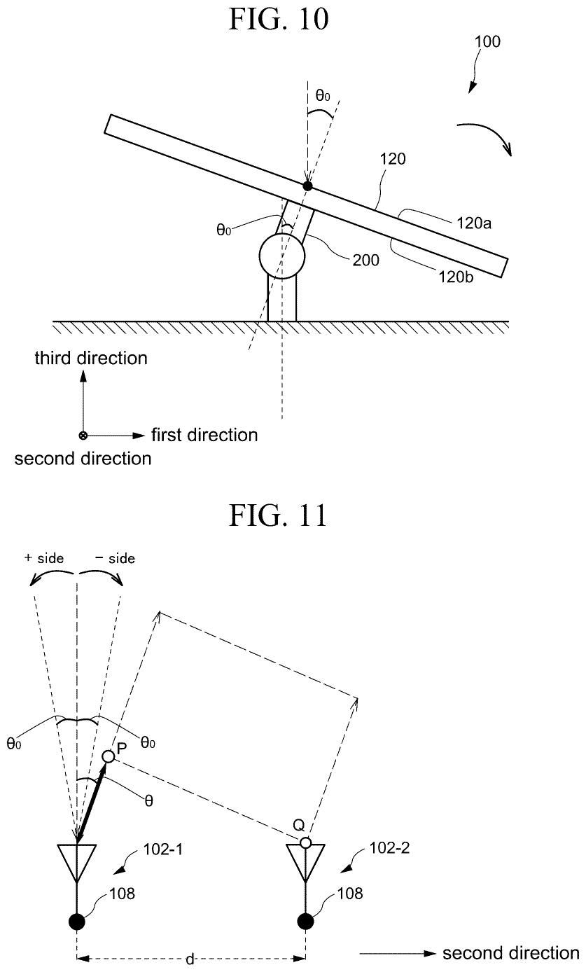

FIG. 10 is a diagram showing a state in which the radio wave reflector 120 is rotated by θ₀ in the left-right direction in the figure about the second direction as an axis. In this case, the incident angle of the radio wave incident on the radio wave reflector 120 from the front is shifted by θ₀. In this way, the incident angle of the radio wave incident on the radio wave reflector 120 of the radio wave reflection unit 100 can be arbitrarily set by rotating the radio wave reflector 120 by the rotating mechanism 200. When the incident angle of the radio wave incident on the radio wave reflector 120 changes, the phase shift amount δ of each reflective element 102 also changes.

FIG. 11 is a diagram for explaining the phase shift amount δ of the reflective element 102 based on the control signal (voltage signal) applied to the patch electrode 108 when the radio wave reflector 120 is rotated by θ₀ by the rotating mechanism 200. FIG. 11 shows the two reflective elements 102-1 and 102-2 adjacent in the second direction. When the radio wave is incident on the radio wave reflector 120 from the front while the radio wave reflector 120 is not rotating (that is, the incident angle of the radio wave is 0°), as shown in FIG. 11, when the radio wave reflector 120 is rotated by θ₀ by the rotating mechanism, the incident angle of the radio wave incident on the radio wave reflector 120 is shifted by ±θ₀ depending on the rotation direction. In this case, when aligning the phases of the radio waves reflected from the two adjacent reflective elements 102-1 and 102-2 in the θ direction, it is sufficient that the phases at point P and point Q in the figure are aligned. Therefore, the phase shift amount δ of each reflective element 102 is determined based on the following Expression 2.

Δ=(2π/λ)×d(sin θ₀−sin θ) (Expression 2)

In Expression 2 described above, λ indicates the wavelength of the radio wave, d indicates the distance (pitch) between the patch electrodes 108 adjacent in one direction, θ indicates the reflection angle, and θ₀ indicates a rotation angle by the rotating mechanism 200. That is, when the radio wave reflector 120 is rotated by θ₀, the voltage of the control signal applied to the patch electrode 108 of the reflective element 102-2 is set so that the phase of the reflected wave from the reflective element 102-2 is delayed by (2π/λ)×d(sin θ₀−sin θ) compared to the reflected wave from the adjacent reflective element 102-1.

As described above, by rotating the radio wave reflector 120 using the rotating mechanism 200, the phase shift amount δ of each reflective element 102 provided on the radio wave reflector 120 changes. Therefore, by adjusting the rotation angle θ₀ of the radio wave reflector 120 by the rotating mechanism 200, the phase shift amount δ is adjusted, and by adjusting the phase shift amount δ, the set phase for each reflective element 102 can also be adjusted. By adjusting the set phase to be within the range of the change in the amount of phase shift of each reflective element 102, the number of reflective elements 102 for which the desired phase cannot be set can be reduced. As a result, the amplitude of the radio wave reflector 120 can be improved.

### Control Device

Next, returning to FIG. 1, the control device 300 will be described. The control device 300 controls the driving of the radio wave reflection unit 100 and the rotating mechanism 200. Although not shown, the control device 300 includes an operation unit that receives user operations, a calculation processing circuit such as a CPU, and storage devices such as RAM and ROM. The control device 300 executes a control program stored in the storage device by the CPU to realize various functions including a drive control function of the radio wave reflection unit 100 and the rotating mechanism 200 in the radio wave reflecting device 10.

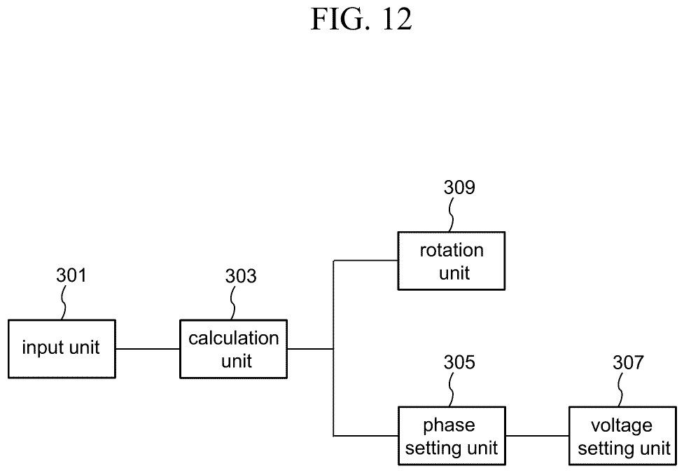

FIG. 12 is a block diagram showing an example of a configuration of a drive control function 30 of the radio wave reflection unit 100 and the rotating mechanism 200 executed by the CPU of the control device 300. The drive control function 30 includes an input unit 301, a calculation unit 303, a phase setting unit 305, a voltage setting unit 307, and a rotation driving unit 309.

The incident angle of the radio wave incident on the radio wave reflector 120 of the radio wave reflection unit 100, the reflection angle of the radio wave reflected by the radio wave reflector 120, and the wavelength of the radio wave, which are set by the user via the operation unit of the control device 300, are input to the input unit 301. The input unit 301 outputs the acquired incident angle, reflection angle, and wavelength of the radio wave to the calculation unit 303.

The calculation unit 303 determines an optimal rotation angle θ₀ of the radio wave reflector 120 by the rotating mechanism 200 and a corresponding optimal phase shift amount δ using the acquired incident angle, reflection angle, and wavelength of the radio wave based on a predetermined algorithm. In this case, the predetermined algorithm is based on a relationship between the phase shift amount δ based on the rotation angle θ₀ of the radio wave reflector 120 by the rotating mechanism 200 and the set phase of each reflective element 102.

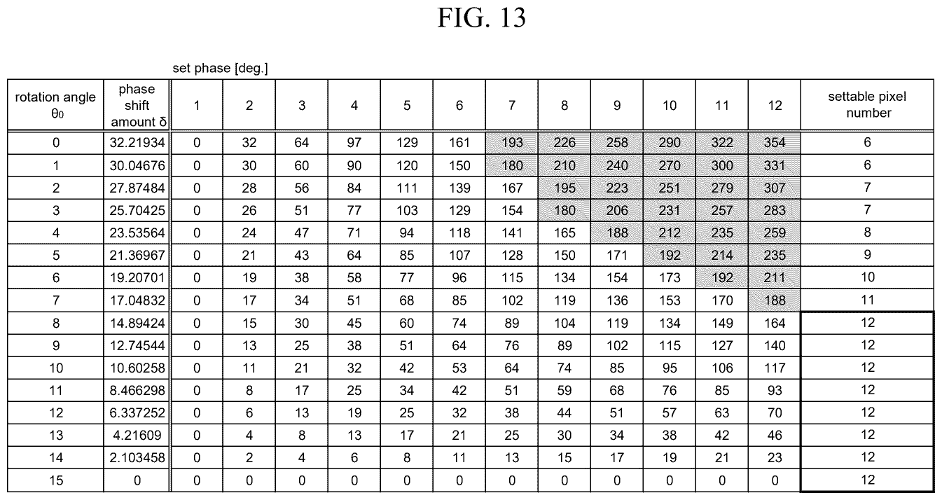

FIG. 13 to FIG. 16 are diagrams showing example calculations of the optimal rotation angle θ₀ of the radio wave reflector 120 and the corresponding optimal phase shift amount δ executed by the calculation unit 303. FIG. 13 to FIG. 16 show the optimal rotation angle θ₀ and the corresponding optimal phase shift amount δ for 12 reflective elements 102 arranged in one direction. Furthermore, in the example calculations of the optimal rotation angle θ₀ and the corresponding optimal phase shift amount δ for the radio wave reflector 120 shown in FIG. 13 to FIG. 16, the maximum rotation angle θ₀ of the rotating mechanism 200 is set to 15°, and the rotating mechanism 200 is assumed to rotate in increments of 1°. In addition, the pitch of each reflective element 102 provided on the radio wave reflector 120 (the distance between adjacent reflective elements 102 in one direction) is set to 3.7 mm, and the change in the amount of phase shift of each reflective element 102 is set to 0°or more and less than 180°.

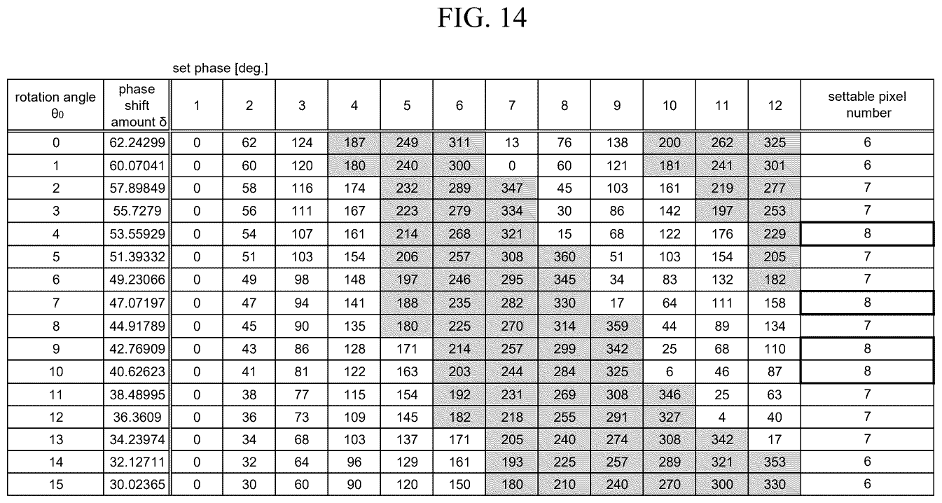

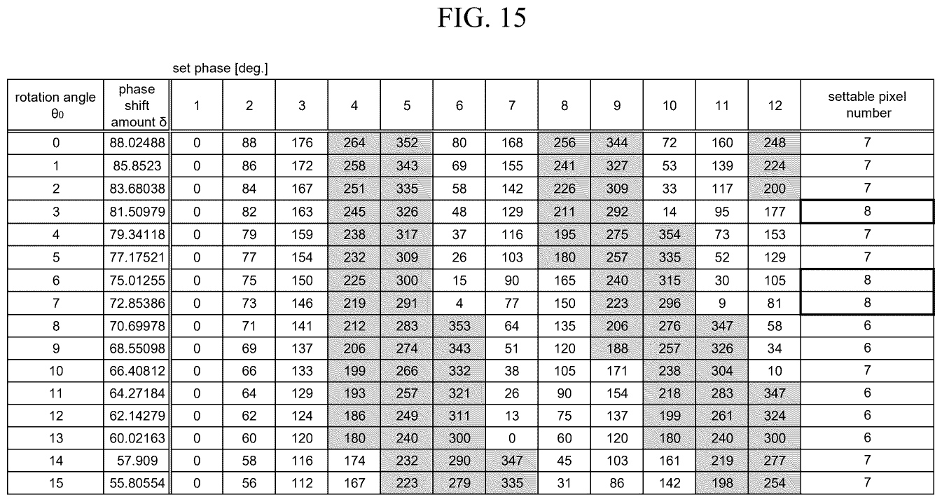

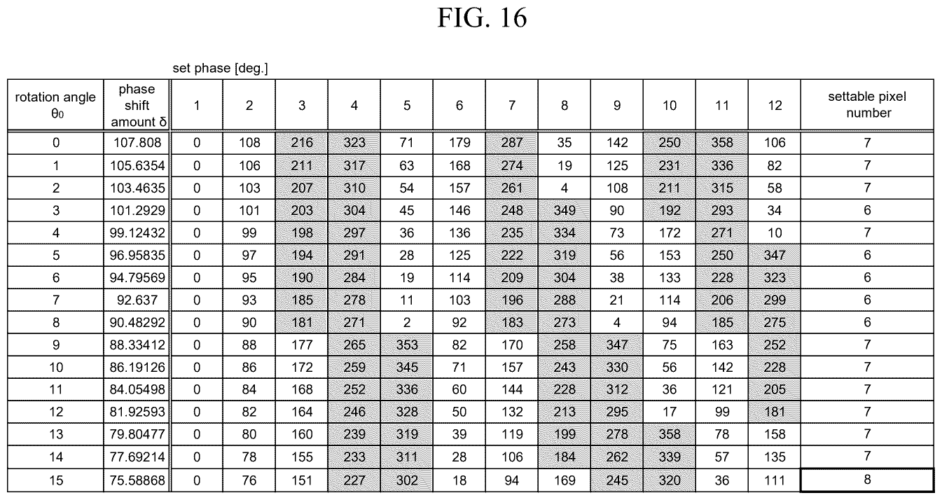

FIG. 13 shows an example calculation of the optimal rotation angle θ₀ and the corresponding optimal phase shift amount δ for the radio wave reflector 120 when the incident angle of the radio wave is set to 0°, a desired reflection angle θ is set to 15°, and the wavelength λ of the radio wave is set to 10.7 mm. FIG. 14 shows an example calculation of the optimal rotation angle θ₀ and the corresponding optimal phase shift amount δ for the radio wave reflector 120 when the incident angle of the radio wave is set to 0°, the desired reflection angle θ is set to 30°, and the wavelength λ of the radio wave is set to 10.7 mm. FIG. 15 shows an example calculation of the optimal rotation angle θ₀ and the corresponding optimal phase shift amount δ for the radio wave reflector 120 when the incident angle of the radio wave is set to 0°, the desired reflection angle θ is set to 45°, and the wavelength λ of the radio wave is set to 10.7 mm. FIG. 16 shows an example calculation of the optimal rotation angle θ₀ and the corresponding optimal phase shift amount δ for the radio wave reflector 120 when the incident angle of the radio wave is set to 0°, the desired reflection angle θ is set to 60°, and the wavelength λ of the radio wave is set to 10.7 mm. The phase shift amount δ of the reflective element 102 corresponding to the rotation angle of the rotating mechanism 200 is calculated based on Expression 2. The set phase for each reflective element 102 is calculated based on the predetermined algorithm as described above. In the set phases shown in FIG. 13 to FIG. 16, the angles shown in gray indicate that the change in the amount of phase shift of each reflective element 102 is 180° or more, and the reflective elements 102 corresponding to the angles shown in gray cannot set the desired phase. Hereinafter, the reflective element 102 that cannot set the desired phase is referred to as a “non-settable element (non-settable pixel)”, and the reflective element 102 that can set the desired phase is referred to as a “settable element (settable pixel)”.

As shown in FIG. 13, when the desired reflection angle is set to 15°, all the 12 reflective elements 102 are settable elements when the rotation angle θ₀ of the rotating mechanism 200 is 8° or more. In this case, the calculation unit 303 selects any rotation angle for the rotating mechanism 200 from 8° to 15° and outputs the selected rotation angle to the rotation driving unit 309. In addition, the calculation unit 303 outputs the phase shift amount δ corresponding to the selected rotation angle to the phase setting unit 305. In this case, when there are multiple options for the rotation angle θ₀, the calculation unit 303 selects the rotation angle with a small change in angle from the angle of the rotating mechanism 200 at that point.

As shown in FIG. 14, when the desired reflection angle is set to 30°, the number of settable elements is maximum (8) when the rotation angle θ₀ of the rotating mechanism 200 is 4°, 7°, 9°, or 10°. In this case, the calculation unit 303 selects any rotation angle from 4°, 7°, 9°, or 10° for the rotating mechanism 200 and outputs the selected rotation angle to the rotation driving unit 309. In addition, the calculation unit 303 outputs the phase shift amount δ corresponding to the selected rotation angle to the phase setting unit 305.

As shown in FIG. 15, when the desired reflection angle is set to 45°, the number of settable elements is maximum (8) when the rotation angle θ₀ of the rotating mechanism 200 is 3°, 6°, or 7°. In this case, the calculation unit 303 selects any rotation angle from 3°, 6°, or 7° for the rotating mechanism 200 and outputs the selected rotation angle to the rotation driving unit 309. In addition, the calculation unit 303 outputs the phase shift amount δ corresponding to the selected rotation angle to the phase setting unit 305.

As shown in FIG. 16, when the desired reflection angle is set to 60°, the number of settable elements is maximum (8) when the rotation angle θ₀ of the rotating mechanism 200 is 15°. In this case, the calculation unit 303 determines the rotation angle of the rotating mechanism 200 to be 15° and outputs the determined rotation angle to the rotation driving unit 309. In addition, the calculation unit 303 outputs the phase shift amount δ corresponding to the rotation angle of 15° to the phase setting unit 305.

As described above, the calculation unit 303 calculates the optimal rotation angle θ₀ of the radio wave reflector 120 by the rotating mechanism 200 and the corresponding optimal phase shift amount δ based on the predetermined algorithm. In this case, the rotation angle θ₀ at which the number of settable elements is maximum, in other words, the number of non-settable elements is minimum, is determined, and the determined rotation angle θ₀ is determined as the optimal rotation angle. The calculation unit 303 outputs the determined rotation angle θ₀ to the rotation driving unit 309 and outputs the phase shift amount δ corresponding to the rotation angle θ₀ to the phase setting unit 305.

The phase setting unit 305 determines the set phase of each reflective element 102 based on the phase shift amount δ acquired from the calculation unit 303. The phase setting unit 305 outputs the determined set phase of each reflective element 102 to the voltage setting unit 307.

The voltage setting unit 307 determines a voltage value to be applied to the patch electrode 108 of each reflective element 102 based on the set phase of each reflective element 102, and outputs the determined voltage value to the first drive circuit 124. The first drive circuit 124 supplies the control signal to the patch electrode 108 of each reflective element 102 based on the voltage value acquired from the voltage setting unit 307.

The rotation driving unit 309 drives the rotating mechanism 200 based on the rotation angle θ₀ acquired from the calculation unit 303 and controls the rotation of the rotating mechanism 200. In addition, the rotation driving unit 309 may be implemented by the rotating mechanism 200 rather than by the control device 300.

As described above, in the present embodiment, the phase shift amount δ is adjusted by adjusting the rotation angle θ₀ of the radio wave reflector 120 by the rotating mechanism 200, thereby making it possible to adjust the set phase for each reflective element 102. By adjusting the set phase so that the number of non-settable elements is minimized, it is possible to reduce the number of reflective elements 102 for which a desired phase cannot be set in the radio wave reflector 120, that is, the number of non-settable elements, and to improve the amplitude of the radio wave reflector 120.

The radio wave reflecting device 10 according to the present embodiment can be used to reflect radio waves included in the range of 24 GHz to 53 GHz (millimeter wave band), such as the 28 GHz, 39 GHz, and 47 GHz wave bands, in a desired direction.

### Modifications

Although an embodiment of the present disclosure has been described above, the present invention can be implemented in various aspects as follows.

### First Modification

In the embodiment described above, the plurality of first signal lines 118 extending in the first direction and the plurality of second signal lines 132 extending in the second direction are disposed in the radio wave reflector 120. However, the configuration of the radio wave reflector 120 is not limited to this. For example, the second signal line 132 may be omitted. In this case, the second drive circuit 130 and the switching element 134 provided in each reflective element 102 can also be omitted.

### Second Modification

In the embodiment described above, the case in which the rotating mechanism 200 has a structure that rotates the radio wave reflector 120 in the left-right direction in the figure, with the second direction as the axis by means of the cylindrical rotating body, has been described. However, the configuration of the rotating mechanism 200 is not limited to this. For example, the rotating mechanism 200 may rotate the radio wave reflector 120 in two axes or three axes. “Two-axes rotation” means rotation around two axes extending in two different directions from each other, and “three-axes rotation” means rotation around three axes extending in three different directions from each other. For example, when the rotating mechanism 200 has a spherical rotating body, the rotating mechanism 200 can rotate the radio wave reflector 120 in two axes. In addition, the rotating mechanism 200 may be, for example, a device that generates power in a linear direction, such as a linear actuator. In this case, by attaching the linear actuator to both ends of the radio wave reflector 120 in a desired rotation direction and driving each linear actuator so that the radio wave reflector 120 rotates to a desired angle, the radio wave reflector 120 can be rotated in one axis, two axes, or three axes. In addition, the rotating mechanism 200 may have, for example, a configuration such as an air cushion that is compressed and extended by supplied air. In this case, by inflating the opposite side of the desired rotation direction, the radio wave reflector 120 can be rotated in one axis or two axes in the desired rotation direction. Furthermore, by adjusting the intake air supply, three-axes rotation can also be achieved.

### Third Modification

In the embodiment described above, when switching the reflection angle of radio waves by the radio wave reflection unit 100, the rotation angle of the radio wave reflector 120 can be changed by the rotating mechanism 200, thereby quickly switching the reflection angle in the radio wave reflection unit 100. In the radio wave reflector 120, depending on the distance between the patch electrode 108 and the conductive layer 110, the response of the liquid crystal in the liquid crystal layer 114 may take some time. In such a case, when changing the reflection angle of radio waves in the radio wave reflector 120, if the difference in the set phase of the reflective element 102 before and after the change in reflection angle is large, switching the reflection angle takes time. On the other hand, by rotating the radio wave reflector 120 by the rotating mechanism 200 and setting the rotation angle by the rotating mechanism 200 so that the difference in the set phase of the reflective element 102 before and after the change in reflection angle is small, switching of the reflection angle can be achieved more quickly without significantly changing the applied voltage between the patch electrode 108 and the conductive layer 110.

The various configurations of the radio wave reflecting device and the reflective element exemplified as an embodiment of the present invention can be appropriately combined and implemented as long as no contradiction is caused. Furthermore, the addition, deletion, or design change of components, or the addition, deletion, or condition change of processes as appropriate by those skilled in the art based on the radio wave reflecting device and the reflective element disclosed in the present specification and drawings are also included in the scope of the present invention as long as they are provided with the gist of the present invention.

Furthermore, it is understood that, even if the effect is different from those provided by each of the embodiments disclosed in the present specification, the effect obvious from the description in the specification or easily predicted by persons ordinarily skilled in the art is apparently derived from the present invention.

What is claimed is:

1. A radio wave reflecting device comprising:
a radio wave reflection unit having a radio wave reflector on which a plurality of reflective elements is arranged;
a rotating mechanism attached to the radio wave reflector and rotating the radio wave reflector about at least one axis; and
a control device controlling the rotation of the radio wave reflector by the rotating mechanism.

2. The radio wave reflecting device according to claim 1, wherein
the radio wave reflector comprises a first surface onto which radio waves are incident and a second surface opposite the first surface, and
the rotating mechanism is attached to the second surface.

3. The radio wave reflecting device according to claim 1, wherein the control device determines a rotation angle of the radio wave reflector based on a predetermined algorithm.

4. The radio wave reflecting device according to claim 3, wherein the predetermined algorithm is based on the relationship between a phase shift amount for each of the plurality of reflector elements, determined based on the rotation angle of the radio wave reflector, and a phase of the reflected wave set for each of the plurality of reflector elements.

5. The radio wave reflecting device according to claim 4, wherein the control device determines the rotation angle of the radio wave reflector based on a phase shift amount of the plurality of reflective elements, such that the number of reflective elements that cannot be set to the desired phase is minimized.

6. The radio wave reflecting device according to claim 3, wherein the control device further determines a phase of the reflected wave set for each of the plurality of reflective elements.

7. The radio wave reflecting device according to claim 6, wherein the control device sets a voltage value for a control signal supplied to each of the plurality of reflective elements based on the determined phase of the reflected wave.

8. The radio wave reflecting device according to claim 7, wherein
the radio wave reflector has a first signal line extending in a predetermined direction and supplying the control signal;
each of the plurality of reflective elements comprises:
a patch electrode;
a conductive layer arranged apart from the patch electrode and facing the patch electrode; and
a liquid crystal layer arranged between the patch electrode and the conductive layer; and
the control signal is applied to the patch electrode.
